(19) United States
(12) Patent Application Publication
(10) Pub. No.: US 2026/0053694 A1
(43) Pub. Date: Feb. 26, 2026

(54) ARMREST MECHANISM AND MASSAGE MACHINE

(71) Applicant: FUJI Medical Instruments MFG. CO.,LTD., Osaka (JP)

(72) Inventor: Jiafu CHEN, Xiamen (CN)

(21) Appl. No.: 19/306,270

(22) Filed: Aug. 21, 2025

(30) Foreign Application Priority Data
Aug. 23, 2024 (CN) 202411170710.9

(51) Int. Cl. A61H 9/00

(52) U.S. Cl. CPC A61H 9/0078; A61H 2201/0149; A61H 2201/1623; A61H 2201/1635; A61H 2201/1664; A61H 2201/1671; A61H 2205/06

(57) ABSTRACT

An armrest mechanism and a massage machine are provided, which make it easy to treat a fixed part of an arm of a treated person, even without restricting the operation of a backrest portion of the massage machine. The armrest mechanism of the present invention is arranged at a seating portion to which a backrest portion is connected in a manner rotatable about a first axis, and comprises an armrest support portion connected to the seating portion in a manner rotatable about a second axis parallel to the first axis; and an armrest portion connected to the backrest portion in a manner rotatable about a third axis parallel to the first axis and arranged on the armrest support portion in a manner slidable in a direction intersecting the first axis.

### TECHNICAL FIELD

The present disclosure relates to an armrest mechanism and the massage machine including an armrest mechanism.

### BACKGROUND ART

In the patent document CN 219439919 U there is disclosed a massage machine, including: a seating portion; a backrest portion rotatably connected to the seating portion; and an armrest portion in which a track portion, a slide portion and a resting portion are provided, the track portion being fixed to the seating portion, and the slide portion being arranged on the track portion and slidable back and forth together with the resting portion and supporting the resting portion from below.

### SUMMARY

### Technical Problem

However, in the massage machine described above, the slide portion and the resting portion move independently of the backrest portion. As the backrest portion is reclined or raised, the slide portion and the resting portion do not move in conjunction with the backrest portion. When the resting portion is provided with a treatment portion such as an airbag for treatment of an arm of a treated person, as the backrest portion is reclined or raised relative to the seating portion, the treated person in the seating portion will be also reclined or raised along with the reclining or raising of the backrest portion. As the back of the treated person is reclined or raised, the arm of the treated person arm will also move accordingly, and is thus likely to perform a significant movement relative to the treatment portion. For example, the arm may move rearwardly away from the treatment portion and cannot receive an effective massage. Therefore, when it is necessary to treat a fixed part of the arm of the treated person, it is generally necessary to limit the operation of the backrest portion.

The present disclosure has been accomplished in view of the above problem, with the aim of providing an armrest mechanism and a massage machine, which make it easy to treat a fixed part of an arm of a treated person, even without limiting the operation of a backrest portion of the massage machine.

### Solution of Problem

In order to achieve the above objective, the present disclosure provides an armrest mechanism arranged at a seating portion to which a backrest portion is connected in a manner rotatable about a first axis, the armrest mechanism including: an armrest support portion connected to the seating portion in a manner rotatable about a second axis parallel to the first axis; and an armrest portion connected to the backrest portion in a manner rotatable about a third axis parallel to the first axis and arranged on the armrest support portion in a manner slidable in a direction intersecting the first axis but not in shaft connection with a rotating shaft parallel to the first axis.

In the armrest mechanism according to the present disclosure, when the armrest mechanism is applied to a massage machine including the seating portion and the backrest portion, the armrest portion moves rearwardly and downwardly as the backrest portion is reclined, and moves forwardly and upwardly as the backrest portion is raised. In this way, when the armrest portion is provided with a treatment portion for treatment of an arm of a treated person, it is easy to treat a fixed part of the arm of the treated person, even without limiting the operation of the backrest portion of the massage machine.

Furthermore, in the armrest mechanism of the present disclosure, preferably, the armrest support portion includes a slide guiding member, the slide guiding member being in the form of an elongated strip and having one end connected to the seating portion in a manner rotatable about the second axis, and the armrest portion includes: a slider supported on the slide guiding member in a manner slidable in a length direction of the slide guiding member but not in shaft connection with the rotating shaft parallel to the first axis; and a connecting portion fixed to the slider in a manner extending from the slider toward the third axis, an end of the connecting portion away from the slider being connected to the backrest portion in a manner rotatable about the third axis.

Furthermore, in the armrest mechanism of the present disclosure, preferably, the armrest portion further includes a resting portion supported on the slider via the connecting portion.

Furthermore, in the armrest mechanism of the present disclosure, preferably, the connecting portion is removable with respect to the slider.

In the armrest mechanism according to the present disclosure, when the rotatable range of the backrest portion with respect to the seating portion is changed, it is only necessary to replace the connecting portion without replacing the slider, facilitating a reduction in the manufacturing cost.

Furthermore, in the armrest mechanism of the present disclosure, preferably, the connecting portion extend from the slider toward the third axis and away from the first axis in a bent manner, as viewed in a direction of extension of the first axis.

When the armrest mechanism according to the present disclosure is applied to the massage machine including the seating portion and the backrest portion, it is easy to increase the rotatable range of the backrest portion as compared to the case where the connecting portion extends in a straight line.

Furthermore, in the armrest mechanism of the present disclosure, preferably, the connecting portion has: a first part extending straight from the slider toward a side where the third axis is located; and a second part extending straight from the first part toward the side where the third axis is located and forming an angle with a direction of extension of the first part.

Furthermore, in the armrest mechanism of the present disclosure, preferably, the armrest support portion includes: a slide guiding member connected to the seating portion in a manner rotatable about the second axis and extending in a sliding direction of the armrest portion; and a rotation guiding member arranged at a position of the slide guiding member away from the second axis and cooperating with a rotation guided member arranged at the seating portion to guide the rotation of the slide guiding member.

In the armrest mechanism according to the present disclosure, it is easy to ensure the stability of the slide guiding member when rotating relative to the seating portion.

Furthermore, in the armrest mechanism of the present disclosure, preferably, the rotation guiding member has one of an arc-shaped elongated hole centered on the second axis and a pin portion inserted into the elongated hole, and the rotation guided member has the other of the elongated hole and the pin portion.

In the armrest mechanism according to the present disclosure, it is easy to simplify the structures of the rotation guiding member and the rotation guided member, thereby reducing the manufacturing cost.

Furthermore, in the armrest mechanism of the present disclosure, preferably, at least one of the rotation guiding member and the rotation guided member is provided with a limiting portion for limiting the relative movement between the rotation guiding member and the rotation guided member in a direction parallel to the first axis.

In the armrest mechanism according to the present disclosure, it is easy to prevent the armrest support portion from shaking left and right.

Furthermore, in the armrest mechanism of the present disclosure, preferably, the second axis is higher than a seating surface of the seating portion.

Furthermore, preferably, the armrest mechanism of the present disclosure further includes a treatment portion supported on the armrest portion to move together with the armrest portion.

Furthermore, in the armrest mechanism of the present disclosure, preferably, the third axis is higher than the second axis in a raised state of the backrest portion.

Furthermore, in order to achieve the above objective, the present disclosure provides a massage machine, including: a seating portion; a backrest portion rotatably connected to the seating portion; and the armrest mechanism described in any of the above items.

In the armrest mechanism according to the present disclosure, when the armrest mechanism is applied to a massage machine including the seating portion and the backrest portion, the armrest portion moves rearwardly and downwardly as the backrest portion is reclined, and moves forwardly and upwardly as the backrest portion is raised. When the treated person in the seating portion is reclined (or raised) as the backrest portion is reclined (or raised), the arm of the treated person will also move rearwardly and downwardly (or forwardly and upwardly) as the back of the treated person is reclined (or raised). In this case, in the massage machine (e.g., a massage chair) having the armrest mechanism of the present disclosure, the armrest mechanism more easily tracks the movement of the arm of the treated person, while ensuring that the arm of the treated person does not leave the armrest mechanism. In this way, when the armrest portion is provided with the treatment portion for treatment of the arm of the treated person, it is easy to treat the fixed part of the arm of the treated person, even without limiting the operation of the backrest portion of the massage machine.

### BRIEF DESCRIPTION OF THE DRAWINGS

FIG. 1 is a side view schematically showing a main body of a massage machine according to an embodiment of the present disclosure, and showing a raised state of a backrest portion.

FIG. 2 is a side view schematically showing the main body of the massage machine according to the embodiment of the present disclosure, and showing a reclined state of the backrest portion.

FIG. 3 is a side view schematically showing part of a seating portion and part of an armrest mechanism of the massage machine according to the embodiment of the present disclosure.

FIG. 4 is a perspective view schematically showing part of the seating portion and part of the armrest mechanism of the massage machine according to the embodiment of the present disclosure.

FIG. 5 is another perspective view schematically showing part of the seating portion and part of the armrest mechanism of the massage machine according to the embodiment of the present disclosure.

FIG. 6 is a side view schematically showing part of the seating portion and the armrest mechanism of the massage machine according to the embodiment of the present disclosure.

### LIST OF REFERENCE SIGNS

1 Massage machine
10 Seating portion
11 First crossbar
12 Second crossbar
121 Rotation guided member
13 First vertical bar
14 Second vertical bar
15 Protruding member
20 Backrest portion
21 Main frame
22 Connecting frame
30 Armrest mechanism
31 Armrest support portion
311 Slide guiding member
312 Rotation guiding member
3121 Elongated plate
3122 Connecting plate
32 Armrest portion
321 Slider
3211 Groove
322 Connecting portion
3221 First side wall
3222 Second side wall
3223 Connecting wall
323 Resting portion
P1 First part
P2 Second part
J Joint

### DESCRIPTION OF EMBODIMENTS

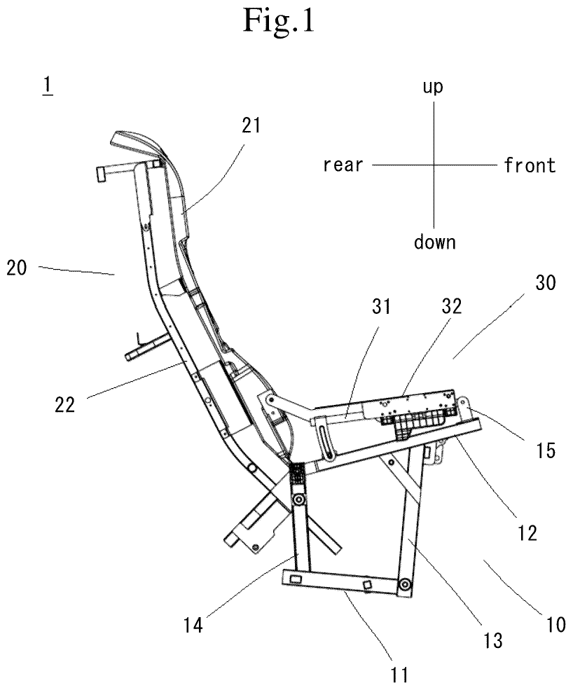

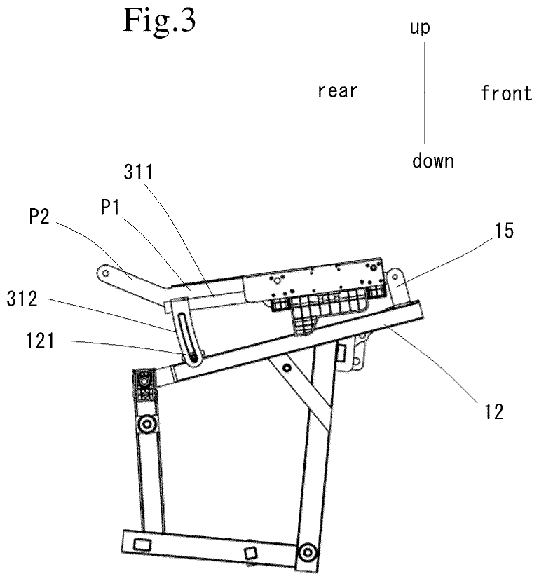

A massage machine according to an embodiment of the present disclosure will be described below with reference to FIGS. 1 to 6.

Here, for convenience of description, the front side (front) when viewed from a treated person sitting in the massage machine with a backrest portion in a non-reclined state is referred to as the “front side” or “front”, and the rear side (back side) when viewed from the treated person sitting in the massage machine with the backrest portion in the non-reclined state is referred to as the “rear side” or “rear”. Furthermore, the upper side (head side) when viewed from the treated person sitting in the massage machine with the backrest portion in the non-reclined state is referred to as the “upper side” or “up”, and the lower side (foot side) when viewed from the treated person sitting in the massage machine with the backrest portion in the non-reclined state is referred to as the “lower side” or “down”. Furthermore, the right side when viewed from the treated person seating in the massage machine is referred to as the “right side” or “right”, and the left side when viewed from the treated person seating in the massage machine is referred to as the “left side” or “left”.

### (Overall Structure of Massage Machine)

As shown in FIGS. 1 to 3, the massage machine 1 includes a seating portion 10, a backrest portion 20 and an armrest mechanism 30. The backrest portion 20 is connected to the seating portion 10 in a manner rotatable about a first axis extending in a left-right direction. The armrest mechanism 30 includes: an armrest support portion 31, the armrest support portion 31 being connected to the seating portion 10 in a manner rotatable about a second axis (further forward than the first axis in the illustrated example) parallel to the first axis; an armrest portion 32, the armrest portion 32 being connected to the backrest portion 20 in a manner rotatable about a third axis (further rearward than the first axis in the illustrated example) parallel to the first axis, and arranged on the armrest support portion 31 in a manner slidable in a direction intersecting (in the illustrated example, perpendicular to) the first axis but not in shaft connection with a rotating shaft parallel to the first axis.

Here, the so-called “first axis” is an axis on which a first rotating shaft for connecting the seating portion 10 and the backrest portion 20 is located. The so-called “second axis” is an axis on which a second rotating shaft for connecting the armrest support portion 31 and the seating portion 10 is located. In this embodiment, the second axis is located on a front end side of the seating portion 10, and is also located on a front end side of the armrest support portion 31. That is, the second rotating shaft rotationally connects the front end side of the armrest support portion 31 to the front end side of the seating portion 10. The so-called “third axis” is an axis on which a third rotating shaft for connecting the armrest portion 32 and the backrest portion 20 is located. In this embodiment, the third axis is located at a higher position than the position of the backrest portion 20 corresponding to the buttocks of the treated person.

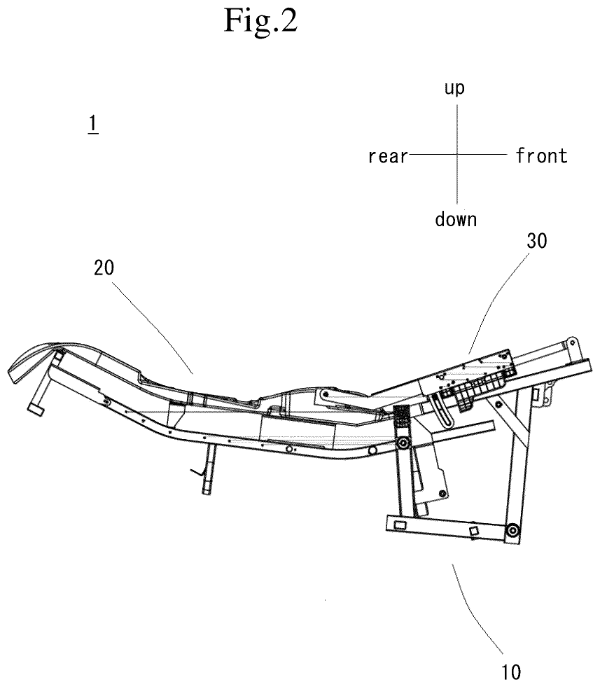

Furthermore, as shown in FIGS. 1 and 2, the massage machine 1 is a massage chair, the seating portion 10 is configured to support the buttocks (or the buttocks and thighs) of the treated person, and the backrest portion 20 is configured to support the spinal back of the treated person and can rotate at a large angle (within the range of motion of the backrest portion 20, the first axis, the second axis and the third axis being arranged in a triangular layout) between the raised state (in which the second axis is lower than the third axis) shown in FIG. 1 and the reclined state (in which the second axis is higher than the third axis) shown in FIG. 2.

Furthermore, although not shown, the massage machine 1 may further include a base which supports the seating portion 10 from below. Moreover, the armrest mechanism 30 may further include a treatment portion having a functional component for performing a massage treatment on the hand or arm. The treatment portion is supported on the armrest portion 32 to move together with the armrest portion 32.

Furthermore, FIGS. 1 to 3 show only part of a main body frame of the massage machine 1. In practice, the massage machine 1 further includes a skin, not illustrated, which covers the main body frame and is generally made of leather, cloth, etc.

### (Structure of Seating Portion)

As shown in FIGS. 1 and 2, the seating portion 10 is provided with a seating portion frame including a left frame and a right frame opposite to each other and spaced apart from each other in the left-right direction.

Here, as shown in FIGS. 1 and 2, the left frame and the right frame are arranged to clamp the backrest portion 20. Moreover, the left frame and the right frame each have a first crossbar 11, a second crossbar 12, a first vertical bar 13 and a second vertical bar 14. The first crossbar 11 and the second crossbar 12 extend substantially in a front-rear direction (in the illustrated example, a distance between the first crossbar 11 and the second crossbar 12 decreases rearwardly, but is not limited thereto, for example, it is also possible that the distance between the first crossbar 11 and the second crossbar 12 remains constant in the front-rear direction), and the second crossbar 12 is located above the first crossbar 11 (an upper surface of the second crossbar 12 is, for example, substantially flush with an upper surface of the seating portion 10 on which the treated person sits, i.e., a seating surface). The first vertical bar 13 and the second vertical bar 14 extend substantially in an up-down direction, for connecting the first crossbar 11 and the second crossbar 12 to each other, and the second vertical bar 14 is located in front of the first vertical bar 13 (in the illustrated example, a distance between the first vertical bar 13 and the second vertical bar 14 decreases downwardly, but is not limited thereto, for example, it is also possible that the distance between the first vertical bar 13 and the second vertical bar 14 remains constant in the up-down direction). Moreover, the left frame and the right frame each have a protruding member 15 protruding upwardly from near a front end of the second crossbar 12.

Furthermore, as shown in FIGS. 1 and 2, in the left frame and the right frame, each of the left and right second crossbars 12 is provided with a Rotation Guided Member 121. Specifically, the Rotation Guided Member 121 is a pin portion extending in the left-right direction, which in this embodiment is arranged on the upper surface near a rear end of the second crossbar 12.

### (Structure of Backrest Portion)

As shown in FIGS. 1 and 2, the backrest portion 20 has a backrest portion frame which is located between the left frame and the right frame of the seating portion 10 in the left-right direction.

Here, as shown in FIGS. 1 and 2, the backrest portion frame includes a main frame 21 and a connecting frame 22. In the state shown in FIG. 1, the main frame 21 and the connecting frame 22 are arranged substantially one in front of the other, and the main frame 21 is located on the front side of the connecting frame 22. Moreover, in the state shown in FIG. 1, the main frame 21 is generally in the form of a gate when viewed in the front-rear direction, and on the left and right sides, the armrest portions 32 of the armrest mechanisms 30 are connected in a manner rotatable about the third axis. The connecting frame 22 is connected to the main frame 21 and is connected to the seating portion 10 in a manner rotatable about the first axis.

### (Structure of Armrest Mechanism)

As shown in FIGS. 1 and 2, a pair of armrest mechanisms 30 are provided in the left-right direction, the left armrest mechanism 30 is connected to the left frame of the seating portion 10 and a left side of the backrest portion 20, and the right armrest mechanism 30 is connected to the right frame of the seating portion 10 and a right side of the backrest portion 20.

Since the left armrest mechanism 30 and the right armrest mechanism 30 are bilaterally symmetrical, only one of them will be described below.

As described above, the armrest mechanism 30 includes the armrest support portion 31 and the armrest portion 32.

Here, as shown in FIGS. 1, 2, 4 and 5, the armrest support portion 31 includes a slide guiding member 311 and a rotation guiding member 312. The slide guiding member 311 is connected to the seating portion 10 in a manner rotatable about the second axis and extends in a sliding direction of the armrest portion 32. The rotation guiding member 312 is arranged at a position of the slide guiding member 311 away from the second axis and cooperates with a rotation guided member 121 arranged at the seating portion 10 to guide the rotation of the slide guiding member 311.

Specifically, in this embodiment, the slide guiding member 311 is in the form of an elongated strip (in the illustrated example, the cross-section is rectangular, but is not limited thereto, and the cross-section may be triangular, oval, circular, etc.), and has one end in shaft connection with the seating portion 10 in a manner rotatable about the second axis. In the illustrated example, the slide guiding member 311 is connected, in a manner rotatable about the second axis, to the protruding member 15 of the seating portion 10 that protrudes upwardly from near the front end of the second crossbar 12. That is, a second rotating shaft (or pin) is fixedly arranged at a position of the protruding member 15 above the seating surface (e.g., the surface substantially flush with the second crossbar 12). The slide guiding member 311 is arranged such that its front end is in shaft connection with the second rotating shaft and its rear end extends toward the rear where the backrest portion 20 is located. The rear end of the slide guiding member 311 is not connected to the backrest portion 20. The front-rear direction from the second rotating shaft to the backrest portion 20 is the sliding direction of the armrest portion 32. However, it is not limited to this. Depending on the situation, it is also possible that the slide guiding member 311 is directly connected to the second crossbar 12 of the seating portion 10. For example, it is also possible that a second rotating shaft extending laterally is provided at the front end of the second crossbar 12, and the front end of the slide guiding member 311 is in shaft connection with this rotating shaft.

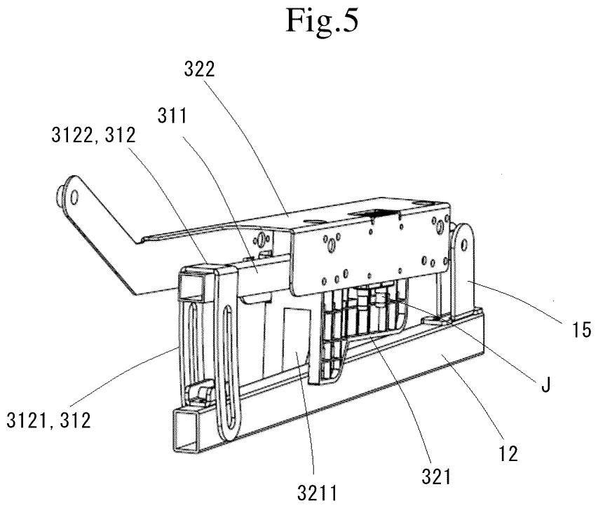

As shown in FIG. 5, the rotation guiding member 312 includes a pair of elongated plates 3121 spaced apart from each other in the left-right direction and a connecting plate 3122 for connecting upper ends of the pair of elongated plates 3121. The pair of elongated plates 3121 are positioned to clamp the slide guiding member 311 from the left and right sides, protrude further downwardly than the slide guiding member 311, and each have an arc-shaped elongated hole centered on the second axis. The connecting plate 3122 abuts against the slide guiding member 311 from above.

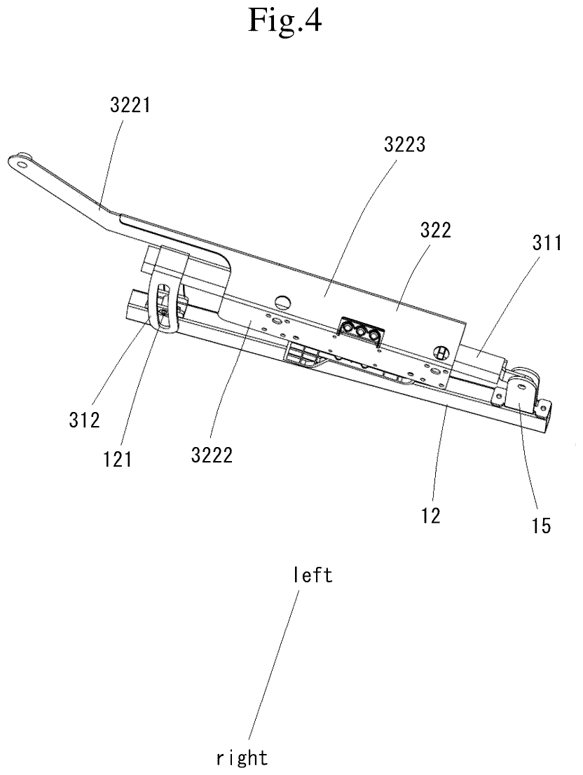

Furthermore, as shown in FIGS. 4 and 5, the armrest portion 32 includes a slider 321 and a connecting portion 322. The slider 321 is supported on the armrest support portion 31 in a manner slidable in a direction intersecting the first axis but not in shaft connection with the rotating shaft parallel to the first axis. The connecting portion 322 is fixed to the slider 321 in a manner extending from the slider 321 toward the third axis, and an end (in the illustrated example, a rear end) of the connecting portion 322 away from the slider 321 is connected to the backrest portion 20 in a manner rotatable about the third axis.

Specifically, the slider 321 has a through hole through which the slide guiding member 311 passes and whose cross-sectional shape and size match the cross-sectional shape and size of the slide guiding member 311, whereby the slider 321 is supported on the slide guiding member 311 in a manner slidable in a length direction of the slide guiding member 311 but not in shaft connection with the rotating shaft parallel to the first axis. As the slide guiding member 311 rotates about the second axis, the slider 321 can rotate with the slide guiding member 311. A bottom of the slider 321 is provided with a groove 3211, which is recessed upwardly and penetrates in the front-rear direction. The groove 3211 is open in the direction of a side frame (e.g. the left frame or the right frame) of the seating portion 10. When the slider 321 has a displacement in the up-down direction as the slide guiding member 311 rotates, the groove 3211 may allow the second crossbars 12 of the left frame and the right frame of the seating portion 10 to be engaged or disengaged. Moreover, in this embodiment, since the groove 3211 has a predetermined width in the left-right direction, it is possible to limit the relative movement between the slider 321 and the second crossbar 12 in the left-right direction.

Specifically, the connecting portion 322 is removably connected to the slider 321, for example, by means of a screw or the like. The connecting portion 322 has a first side wall 3221, a second side wall 3222, and a connecting wall 3223. The first side wall 3221 and the second side wall 3222 extend in the length direction of the slide guiding member 311 and clamp the slider 321 from the left and right sides. The connecting wall 3223 connects upper ends of the first side wall 3221 and the second side wall 3222. The connecting portion 322 has a part extending from the slider 321 toward the third axis and away from the first axis (in the illustrated example, the upper side) in a bent manner, as viewed in a direction of extension of the first axis. Specifically, the first side wall 3221 has a first part P1 and a second part P2. The first part P1 extends straight from the slider 321 toward the side where the third axis is located. The second part P2 extends straight from the first part P1 toward the side where the third axis is located and forms an angle with a direction of extension of the first part P1. In this way, the first part P1 and the second part P2 are formed to connect the slider 321 to the backrest portion 20 and have a part extending from the slider 321 toward the third axis in a bent manner. The first part P1 and the second part P2 are formed as a bent structure in which the second part P2 extends further above the slider 321 than the first part P1. Since a distance between the backrest portion 20 and a front end of the armrest mechanism 30 (the end at which the second rotating shaft is located) is limited, the bent extension structure formed by the first part P1 and the second part P2 can increase a sliding distance by which the slider 321 slides along the slide guiding member 311, that is, can increase the movement distance of the armrest portion 32. Of course, it is also possible that the first part P1 and the second part P2 are formed as a connecting member extending straight from the slider 321 toward the third axis.

In this way, when the backrest portion 20 is tipped rearwardly from the raised state with respect to the seating portion 10, the backrest portion 20 moves the connecting portion 322 rearwardly and downwardly by means of the third rotating shaft, thereby moving the slider 321 rearwardly and downwardly by means of the connecting portion 322. Specifically, the slider 321 slides rearwardly along the slide guiding member 311 to achieve a rearward movement following the connecting portion 322, and drives the slide guiding member 311 to rotate downwardly such that the front end of the slide guiding member 311 is rotated downwardly about the second rotating shaft, to achieve a downward movement following the connecting portion 322. In this way, when the backrest portion 20 is tipped rearwardly, as the backrest portion 20 rotates, the slider 321 has both a sliding movement along the slide guiding member 311 and a rotational movement following the rotation of the slide guiding member 311 about the second axis.

In this embodiment, in the raised state of the backrest portion 20 (i.e., not tipped rearwardly), the third axis is positioned higher than the second axis with respect to the massage machine 1. Compared with a situation where the third axis and the second axis are at the same level when the backrest portion 20 is in the raised state, the structure in which the third axis is higher than the second axis can increase the sliding distance by which the slider 321 slides along the slide guiding member 311 during the movement of the slider 321 following the rotation (rearward tilting) of the backrest portion 20.

Furthermore, since the front end of the slide guiding member 311 (the front end of the armrest support portion 31) is in shaft connection with the second rotating shaft, and the rear end is not connected to the backrest portion 20, the slide guiding member 311 is linked to the rotation position of the backrest portion 20 by means of the armrest portion 32. The position of the rear end of the slide guiding member 311 in the up-down direction depends on the angle of the backrest portion 20 relative to the seating portion 10.

Furthermore, since the front end of the armrest portion 32 is not connected to the second rotating shaft (the seating portion 10), the rear end is in shaft connection with the backrest portion 20, and the slide guiding member 311, which serves as a slide guiding rail of the armrest portion 32, can be rotated about the second axis, the armrest portion 32 can move following the rotation of the backrest portion 20. In this way, with such a simple structure, the armrest portion 32 can be moved both downwardly with the backrest portion 20 and rearwardly with the backrest portion 20.

Furthermore, as shown in FIGS. 4 and 5, a joint J is provided on the second side wall 3222 of the connecting portion 322. The joint J can be connected to an external air pump via a piping.

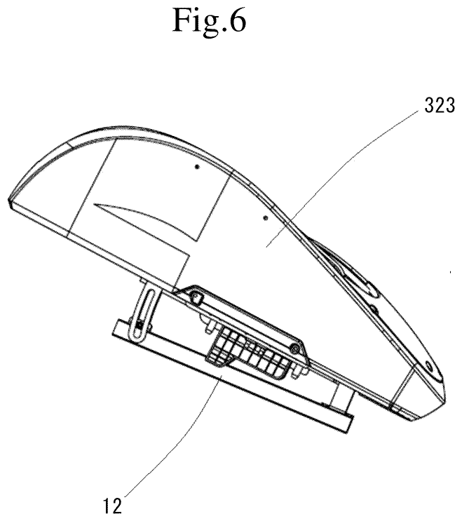

Furthermore, as shown in FIG. 6, the armrest portion 32 further includes a resting portion 323. The resting portion 323 is formed with a recess for resting the arm of the treated person. Moreover, the resting portion 323 is supported on the slider 321 via the connecting portion 322. The resting portion 323 covers the connecting portion 322 from above.

### (Operation of Massage Machine)

When the backrest portion 20 starts to be reclined from the raised state shown in FIG. 1, the armrest portion 32 is pulled toward the rear side and the lower side by the backrest portion 20, thereby moving the armrest support portion 31 downwardly, whereby a rear end of the armrest support portion 31 rotates downwardly about the second axis.

On the contrary, when the backrest portion 20 is raised from the reclined state shown in FIG. 2, the armrest portion 32 is pushed toward the front side and the upper side by the backrest portion 20, thereby pulling the armrest support portion 31 upwardly, whereby the rear end of the armrest support portion 31 rotates upwardly about the second axis.

In the massage machine 1 according to this embodiment, the armrest mechanism 30 includes: an armrest support portion 31, the armrest support portion 31 being connected to the seating portion 10 in a manner rotatable about a second axis parallel to the first axis; and an armrest portion 32, the armrest portion 32 being connected to the backrest portion 20 in a manner rotatable about a third axis parallel to the first axis, and arranged on the armrest support portion 31 in a manner slidable in a direction intersecting the first axis but not in shaft connection with a rotating shaft parallel to the first axis. Therefore, the armrest portion 32 moves rearwardly as the backrest portion 20 is reclined and forwardly as the backrest portion 20 is raised. In this way, when the armrest portion 32 is provided with the treatment portion for treatment of the arm of the treated person, it is easy to treat the fixed part of the arm of the treated person, even without limiting the operation of the backrest portion 20 of the massage machine 1.

The present disclosure has been exemplarily described above in conjunction with the accompanying drawings, and obviously, the specific implementation of the present disclosure is not limited to the above embodiments.

For example, in the above embodiment, the massage machine 1 is a massage chair, but is not limited thereto. It is also possible that the massage machine 1 is a massage bed, etc.

Furthermore, in the above embodiment, the treatment portion may be an airbag, or a vibrating member, a heater, etc.

Furthermore, in the above embodiment, the treatment portion may be arranged at either a wall surface (e.g., the connecting portion 322) of the armrest portion 32 opposite the arm of the treated person in the left-right direction or at a wall surface of the armrest portion 32 opposite the arm of the treated person in the up-down direction.

Furthermore, in the above embodiment, the treatment portion may be fixed either to the slider 321 via the connecting portion 322 or directly to the slider 321.

Furthermore, in the above embodiment, the rotation guiding member 312 has an arc-shaped elongated hole centered on the second axis, and the rotation guided member 121 has a pin portion inserted into the elongated hole, but not limited thereto. It is also possible that the rotation guided member 121 has an arc-shaped elongated hole centered on the second axis, and the rotation guiding member 312 has a pin portion inserted into the elongated hole.

Furthermore, in the above embodiment, it is also possible that at least one of the rotation guiding member 312 and the rotation guided member 121 is provided with a limiting portion which limits the relative movement between the rotation guiding member 312 and the rotation guided member 121 in a direction parallel to the first axis (e.g., a screw that is screwed into the pin portion to limit the left and right movement of the rotation guiding member 312 from two sides together with the pin portion).

Furthermore, it is also possible that the rotation guiding member 312 and/or the rotation guided member 121 has a function of preventing the slider 321 from disengaging from the rear end of the slide guiding member 311. For example, the dimension of the rotation guiding member 312 and/or the rotation guided member 121 in the left-right direction is larger than the width of the groove of the slider 321 in the left-right direction.

Furthermore, in the above embodiment, the armrest support portion 31 includes the slide guiding member 311 and the rotation guiding member 312, but is not limited thereto. It is also possible that the rotation guiding member 312 is omitted.

Furthermore, in the above embodiment, the armrest portion 32 includes the slider 321 and the connecting portion 322 which is removable with respect to the slider 321, but is not limited thereto. It is also possible that the slider 321 and the connecting portion 322 are formed in one piece.

Furthermore, in the above embodiment, in the armrest portion 32, the connecting portion 322 may alternatively be formed in an arc shape, or in the shape of a straight line.

Furthermore, the armrest mechanism 30 in the above embodiment is not limited to use in a massage machine. It will be appreciated that the massage machine or the massage chair according to the present disclosure may be provided with other treatment mechanisms in addition to the treatment portion of the armrest mechanism, such as a lower limb treatment mechanism or a back treatment mechanism.

It will be appreciated that within the scope of the present disclosure, various parts of the embodiments can be freely combined, or various parts of the embodiments can be appropriately modified or omitted.

### LIST OF REFERENCE SIGNS

1 Massage machine
10 Seating portion
11 First crossbar
12 Second crossbar
121 Rotation guided member
13 First vertical bar
14 Second vertical bar
15 Protruding member
20 Backrest portion
21 Main frame
22 Connecting frame
30 Armrest mechanism
31 Armrest support portion
311 Slide guiding member
312 Rotation guiding member
3121 Elongated plate
3122 Connecting plate
32 Armrest portion
321 Slider
3211 Groove
322 Connecting portion
3221 First side wall
3222 Second side wall
3223 Connecting wall
323 Resting portion
P1 First part
P2 Second part
J Joint

What is claimed is:

1. An armrest mechanism, arranged at a seating portion to which a backrest portion is connected in a manner rotatable about a first axis, comprising:
an armrest support portion connected to the seating portion in a manner rotatable about a second axis parallel to the first axis; and
an armrest portion connected to the backrest portion in a manner rotatable about a third axis parallel to the first axis and arranged on the armrest support portion in a manner slidable in a direction intersecting the first axis.

2. The armrest mechanism according to claim 1, wherein
the armrest support portion includes a slide guiding member, the slide guiding member being in the form of an elongated strip and having one end connected to the seating portion in a manner rotatable about the second axis, and
the armrest portion includes:
a slider supported on the slide guiding member in a manner slidable in a length direction of the slide guiding member; and
a connecting portion fixed to the slider in a manner extending from the slider toward the third axis, an end of the connecting portion away from the slider being connected to the backrest portion in a manner rotatable about the third axis.

3. The armrest mechanism according to claim 2, wherein
the armrest portion further includes a resting portion supported on the slider via the connecting portion.

4. The armrest mechanism according to claim 2, wherein
the connecting portion extend from the slider toward the third axis and toward a side away from the first axis in a bent manner, as viewed in a direction of extension of the first axis.

5. The armrest mechanism according to claim 4, wherein
the connecting portion includes:
a first part extending straight from the slider toward a side where the third axis is located; and
a second part extending straight from the first part toward the side where the third axis is located and forming an angle with a direction of extension of the first part.

6. The armrest mechanism according to claim 1, wherein
the armrest support portion includes:
a slide guiding member connected to the seating portion in a manner rotatable about the second axis and extending in a sliding direction of the armrest portion; and
a rotation guiding member arranged at a position of the slide guiding member away from the second axis and cooperating with a rotation guided member arranged at the seating portion to guide the rotation of the slide guiding member.

7. The armrest mechanism according to claim 6, wherein
the rotation guiding member has one of an arc-shaped elongated hole centered on the second axis and a pin portion inserted into the elongated hole, and the rotation guided member has the other of the elongated hole and the pin portion.

8. The armrest mechanism according to claim 6, wherein
at least one of the rotation guiding member and the rotation guided member is provided with a limiting portion for limiting the relative movement between the rotation guiding member and the rotation guided member in a direction parallel to the first axis.

9. The armrest mechanism according to claim 1, further comprising a treatment portion supported on the armrest portion to move together with the armrest portion.

10. The armrest mechanism according to claim 1, wherein
the second axis is higher than a seating surface of the seating portion.

11. The armrest mechanism according to claim 1, wherein
the third axis is higher than the second axis in a raised state of the backrest portion.

12. A massage machine comprising:
a seating portion;
a backrest portion rotatably connected to the seating portion; and
the armrest mechanism according to claim 1.
